(19) United States
(12) Patent Application Publication
(10) Pub. No.: US 2015/0118599 A9
(43) Pub. Date: Apr. 30, 2015

(54) Composite Filaments having Thin Claddings, Arrays of Composite Filaments, Fabrication and Applications Thereof

(71) Applicant: The Trustees of Columbia University in the City of New York, New York, NY (US)

(72) Inventor: Joze Bevk, Cliffside Park, NJ (US)

(21) Appl. No.: 14/188,463

(22) Filed: Feb. 24, 2014

Related U.S. Application Data
(63) Continuation of application No. PCT/US12/52355, filed on Aug. 24, 2012.
(60) Provisional application No. 61/527,678, filed on Aug. 26, 2011.
(60) Provisional application No. 61/527,682, filed on Aug. 26, 2011.
(60) Provisional application No. 61/527,686, filed on Aug. 26, 2011.
(60) Provisional application No. 61/533,552, filed on Sep. 12, 2011.
(60) Provisional application No. 61/691,578, filed on Aug. 21, 2012.

(51) Int. Cl. B01J 23/50; H01M 4/90; H01M 4/88; B01J 23/89; B01J 23/52

(52) U.S. Cl. CPC B01J 23/50; B01J 23/8993; B01J 23/8906; B01J 23/8926; B01J 23/52; B01J 23/898; H01M 4/8875; H01M 4/9041
USPC 429/524; 502/100; 502/317; 502/318; 502/325; 502/330; 502/331; 502/339; 502/344; 502/345; 502/347; 502/355; 264/104; 216/13; 429/532; 429/526; 429/525

(57) ABSTRACT

A method of fabricating composite filaments is provided. An initial composite filament including a core and a cladding (such as a Pt-group metal) is cut into smaller pieces (or is first mechanically reduced and then cut into smaller pieces). The smaller pieces of the filaments are inserted into a metal matrix, and the entire structure is then further reduced mechanically in a series of reduction steps. The process can be repeated until the desired cross sectional dimension of the filaments is achieved. The matrix can then be chemically removed to isolate the final composite filaments with the cladding thickness down to the nanometer range. The process allows the organization and integration of filaments of different sizes, compositions, and functionalities into arrays suitable for various applications. Materials and components made from such composite filaments and arrays of composite filaments are also disclosed,

### CROSS REFERENCE TO RELATED APPLICATIONS

This application is a continuation of PCT/US12/052355, filed Aug. 24, 2012 and which claims priority from U.S. Provisional Application No. 61/527,678, filed Aug. 26, 2011; U.S. Provisional Application No. 61/527,682, filed Aug. 26, 2011; U.S. Provisional Application No. 61/527,686, filed Aug. 26, 2011; U.S. Provisional Application No. 61/533,552, filed Sep. 12, 2011; and U.S. Provisional Application No. 61/691,578, filed Aug. 21, 2012, the disclosure of each of which is herein incorporated by reference in its entirety.

### BACKGROUND

Nanostructured filamentary catalysts are a class of catalytic materials that can combine high surface area of conventional platinum group metal (PGM) catalysts with the requirement for their reduced consumption and ability to integrate the filaments of different sizes, compositions, and functionalities into arrays suitable for various applications.

Precious metals, such as platinum (Pt) and palladium (Pd), have been used in numerous industrial applications, ranging from automobile catalytic converters, as catalysts in fuel cells, as electrodes in electrolysis and medical research, as sensing elements and conductors in automobile and aerospace industries, gas sensors, etc.

Automotive catalytic converters have evolved from relatively simple devices to sophisticated emission control systems, incorporating advanced catalytic materials and multiple sensors that, in combination with a computerized closed-loop feedback fuel injection system, provide greatly-improved engine performance and emission control. One component of the emission control system is the three-way catalytic converter (“TWC”) that reduces the three main pollution products (carbon monoxide (CO), hydrocarbons (HCs) and NOx) by more than 99%. A conventional TWC can include a monolithic ceramic (sometimes metallic) support with open channel, honeycomb structure. This support can be washcoated with a slurry of Al₂O₃ (or other material) and finally dipped in a solution of precious metal salts, resulting in a dispersion of catalytic metal nanoparticles (Pt, Rh, Pd) inside the pores of the washcoated layer. One aspect of TWC technology is controlling the air-to-fuel ratio close to the stoichiometric ratio using an O₂ sensor positioned before (e.g., immediately before) the catalyst in the exhaust manifold.

The warm-up time for a typical TWC catalyst, which can be located some 70-80 cm from the exhaust manifold, can be about two minutes, during which the catalyst can be largely ineffective at reducing emissions. The addition of a low-mass, “close-coupled” catalyst, located closer to the engine exhaust port, can alleviate this problem as it can reach the HC “light-off” temperature (about 300 degrees Celsius) in as little as 8-10 seconds. One function of the close-coupled catalyst is to oxidize HCs during the first two minutes after the ignition. The TWC catalyst can continue to function following warm-up by eliminating the remaining CO, HCs and NOx. In the close-coupled converters, the catalyst can operate at very high temperatures. Thermal stability and resistance to poisoning are among the main considerations in the design of the close-coupled catalysts.

Improvements in both engine design and in catalytic converter performance are needed to meet ever stricter emission regulations, leading to a Zero Level Emission Vehicle (ZLEV). Even meeting the Ultra-Low Emission Vehicle (ULEV) goal will require development of new technologies. Certain technologies use a Palladium (Pd) close-coupled catalyst on a 1200 cspi monolith and an HC trap hybrid catalyst.

Platinum (Pt)-based electrodes can also be used as components of a Proton Exchange Membrane (PEM) fuel cell, which is used in residential and transportation applications due to its high energy density. Pt can serve as the electrocatalyst at both the anode and the cathode of such fuel cells. Due to its high cost and limited supply, reducing the amount of platinum required (and thus cost) is highly desirable.

Ozone converters can be used to decompose ozone in the intake air of the high-flying aircraft. An ozone converter can be 20-30 cm in diameter and 40-50 cm long and housed in a metallic canister similar to an automobile catalytic converter. Ozone catalysts, such a 1% Pd loaded on γ-Al₂O₃, can be supported on ceramic or metallic monoliths or honeycombs. However, in such designs, the air entering the ozone converter needs to be preheated from about −40° C. to about 200° C. to activate the Pd catalyst and then cooled down to the room temperature before entering the passenger cabin. Further, catalyst deactivation can occur due to masking or poisoning by various contaminants that can condense or deposit on the outermost layers of the washcoat, preventing access to the catalytic sites. For example, some ozone converters can function for 10,000 to 20,000 flight hours before requiring replacement or regeneration. It is desirable to reduce the size, weight, cost (especially the amount of Pd used) and the energy consumption of the ozone converter.

For many applications involving precious metals, the precious metals can be in the form of a thin wire or tape. Pt and Pd and their alloys are readily available in rod, wire, tape and tube forms of various shapes and sizes, ranging from ˜25 mm to sub-micron sizes. For large diameter rods and tubes, the cost of the metal itself typically dominates the overall cost of the product. As the diameter of the rods, wires and tubes and the foil thickness decrease, the processing costs become increasingly more important and eventually overtake the cost of the starting metal or alloy.

There is a need to develop techniques to improve efficient use of precious metals, such as Pt, and Pd, and reduce the cost of fabricating materials or components including precious metals.

### SUMMARY

The disclosed subject matter provides techniques for fabricating micro-sized composite filaments, the composite filaments obtained therefrom, and components made from such composite filaments for various applications. Mechanical reduction techniques can be used to produce a single or an array of multiple micron size filaments, each consisting of a metal core and a thin, nanometer sized cladding of PGM or other expensive metals.

In an exemplary embodiment, a method is provided for fabricating micro-sized composite filaments from an initial composite filament having a first cross sectional dimension. The initial composite filament includes a core made from a first material, and a cladding made from a second material and enclosing the core. The initial composite filament can be first mechanically reduced to produce an intermediate composite filament having a reduced cross sectional dimension. The intermediate composite filament can be cut into two or more shorter filaments, which can be inserted side by side into a first matrix made from a third material, which can be the same as the first material. The resulting structure can be further mechanically reduced to reduce the cross sectional dimensions of the two or more shorter filaments. The two or more shorter filaments so obtained can be isolated from the first matrix.

In some embodiments, obtaining the initial composite filament includes inserting the core into a tube of the cladding. In alternative embodiments, obtaining the initial composite filament includes coating the core with a layer of the cladding.

In some embodiments, the first matrix has a tubular structure, and the inserting includes inserting the two or more shorter filaments as a bundle into the first matrix. In other embodiments, the first matrix includes a plurality of cylindrical holes, and the inserting includes inserting the two or more shorter filaments individually into the plurality of cylindrical holes of the first matrix. In certain embodiments, the matrix material is the same as the core material.

In some embodiments, the first material includes a metal such as Ag or Cu. In certain embodiments, the first material includes multiphase composite such as Ag-Cu, Cu-Nb, Cu-V, Cu-Ta, and Cu-Fe, or a multilayer composite such as Cu-Ni or Cu-NiCr. In certain embodiments, the first material can be an aluminum-based alloy. In some embodiments, the second material includes at least one of Pt, Ru, Rh, Pd, Os, Ir, and Au. In certain embodiments, the third material can be Ag or Cu.

In some embodiments, the initial composite filament can be annealed before mechanical reduction. In some embodiments, the initial composite filament further includes a compatibility layer positioned between the core and the cladding. In some embodiments, the isolating includes chemically etching the first matrix material.

In some embodiments, the final isolated filaments can have a thickness of cladding of about or smaller than 10 nm. In some embodiments, the cross sectional dimension of the final isolated filament is about or smaller than 2 micron.

In some embodiments, the method further includes cutting the mechanically reduced first matrix with two or more shorter filaments (for example, a few dozen to a few hundred) embedded therein into a plurality of composite structures; inserting the plurality of composite structures into a second matrix made from a fourth material; and mechanically reducing the second matrix with the plurality of composite structures inserted therein.

In some embodiments, the method further includes forming an array of the reduced filaments (before isolation), e.g., weaving the filaments into a fabric. The array forming can include adding reinforcing fibers, e.g., weaving the reinforcing fibers into the fabric.

An alternative method for fabricating micro-sized composite filaments includes obtaining at least one initial composite filament having a first cross sectional dimension, the initial composite filament including a core made from a first material and a cladding made from a second material and enclosing the core. The initial composite filament can be inserted into a first matrix made from a third material. The first matrix with the embedded composite filament can be mechanically reduced, thereby obtaining at least one filament having a reduced cross sectional dimension. The filament having the reduced cross sectional dimension can be isolated from the first matrix. In one embodiment, the at least one initial composite filament includes a plurality of initial filaments, and the plurality of initial filaments can be inserted into the first matrix. The plurality of initial filaments can include filaments having different compositions or sizes. In another embodiment, the initial composite filament further includes an outer layer made from a fourth material in contact with the cladding. Such fourth material can be the same material as the third material.

In another aspect, a composite filament is provided which includes a core made from a first material including a metal such as Ag and Cu and a cladding made from a second material and enclosing the core. The second material can be Pt, Ru, Rh, Pd, Os, Ir, and Au. Such a composite filament can be made by any of the procedures described above. The cladding thickness of the composite filament can be about or smaller than 50 nm, or about or smaller than 10 nm. In one embodiment, the first material includes Ag, and the second material includes Pt.

The disclosed subject matter further provides an array of the composite filaments, such as a woven fabric, a non-woven structure, an open network, or other aggregation forms of the composite filaments described above. Such array of the composite fibers can further include reinforcing fibers. The array of composite fibers can be included in an electrode of an electrochemical cell, e.g., a hydrogen fuel cell, as a catalytic material in an ozone converter to decompose ozone, and as a catalytic material for a catalytic converter in an automobile to remove pollutants in the exhaust gas.

### BRIEF DESCRIPTION OF THE DRAWINGS

The accompanying drawings, which are incorporated and constitute part of this disclosure, illustrate some embodiments of the disclosed subject matter.

FIG. 1 is a block diagram of an example process of fabricating composite filaments according to some embodiments of the disclosed subject matter.

FIGS. 2A-2F are a schematic diagram of an example process of fabricating composite filaments according to some embodiments of the disclosed subject matter.

FIG. 3 is a schematic diagram of an apparatus for mechanical reduction in the fabrication of the composite filaments according to some embodiments of the disclosed subject matter.

### DETAILED DESCRIPTION

The disclosed subject matter provides techniques for fabricating micro-sized composite filaments and arrays thereof. The filaments can each have a core of a first metal and a thin cladding of a second metal, e.g., a precious material such as Pt or Pd and their alloys. In some embodiments, the thickness of the cladding of the precious metal can be 10 nm or smaller, or 5 nm or smaller. Therefore, these filaments can provide very high specific surface area for the precious metals, including platinum group metals PGMs (Pt, Pd, Rh, and others). As many catalytic reactions involving the precious metals are surface phenomena, utilizing arrays or open networks of such filaments can significantly reduce the amount of precious metals required for many industrial applications, such as catalytic converters, fuel cells, batteries, or chemical catalysis in general. In addition, the core material can lend the composite filaments with improved properties such as mechanical strengths, thermal and electric conductance, as compared with similar filaments if made only by such precious metals, thereby providing advantages and flexibility in manufacturing desired materials and/or components.

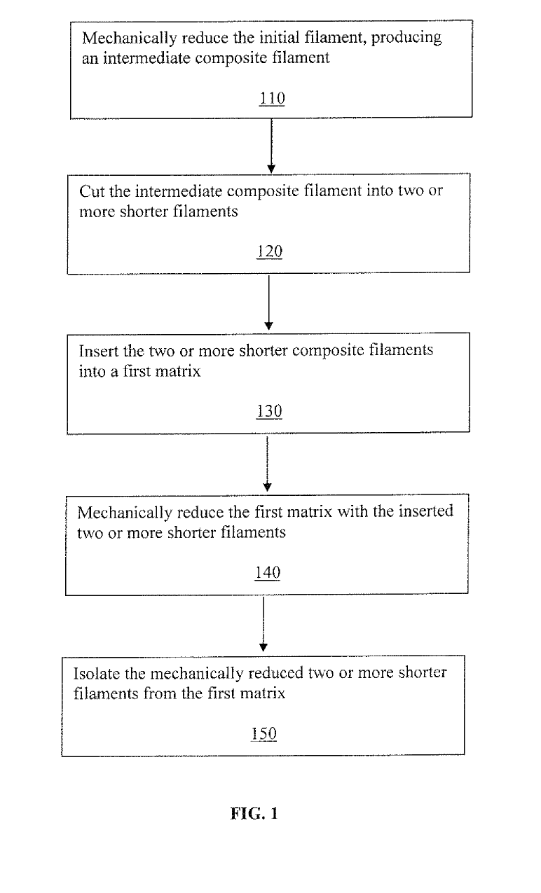

In one aspect of the disclosed subject matter, a method of fabricating micro-sized composite filaments is provided. As illustrated in FIG. 1, the method can start with an initial composite filament, which has a first cross sectional dimension, and includes a core made from a first material as well as a cladding made from a second material and enclosing the core. At 110, the initial composite filament is mechanically reduced to produce an intermediate composite filament having a reduced cross sectional dimension. At 120, the intermediate composite filament is cut into two or more shorter filaments. At 130, the two or more shorter composite filaments obtained from 120 are inserted side by side into a first matrix made from a third material. At 140, the first matrix with the two or more shorter filaments are mechanically reduced to further reduce the cross sectional dimensions of the two or more shorter filaments. At 150, the two or more shorter filaments having further reduced cross sectional dimensions are isolated from the first matrix.

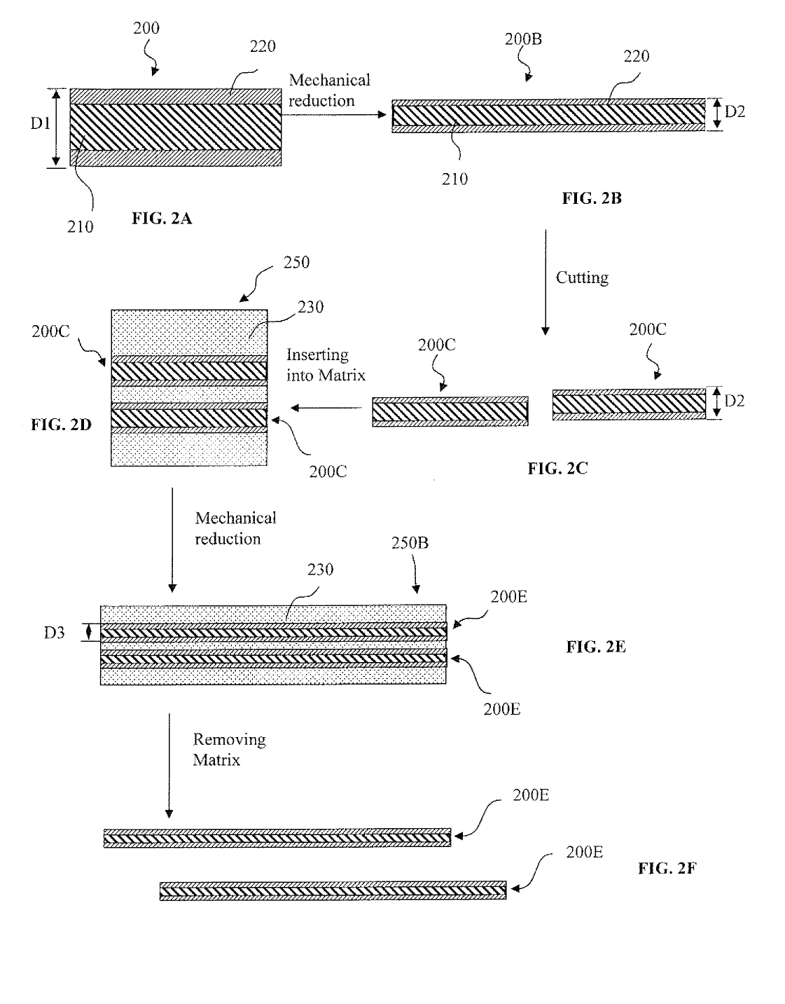

The above process is further illustrated in FIGS. 2A-2F. An initial composite filament (200) having a first cross sectional dimension (D1) can be obtained (in FIG. 2A), which includes a core (210) made from a first material and a cladding (220) made from a second material and enclosing the core. The initial composite filament (200) can be mechanically reduced to produce an intermediate composite filament (200B) having a reduced cross sectional dimension (D2) (in FIG. 2B). The intermediate composite filament can be cut into two or more shorter filaments (200C) (in FIG. 2C). The shorter filaments (200C) can be inserted side by side into a first matrix (230) made from a third material (in FIG. 2D). The structure (250) including the first matrix (230) and the shorter filaments 200C embedded therein is mechanically reduced to produce further reduced two or more shorter filaments (in FIG. 2E). The resulting further reduced shorter filaments (200E, having a cross sectional dimension of D3) can be isolated from the first matrix, e.g., by chemically removing the matrix (in FIG. 2F).

The procedure as shown in FIGS. 2A-2F, or a portion thereof, can be repeated as needed to produce final filaments having desired dimensions. For example, the isolated filaments 200E shown in FIG. 2F can be further cut into a plurality of shorter filaments, and then inserted to a second matrix (made from a same or different material from that of the first matrix), and the second matrix and the plurality of shorter filaments can be mechanically reduced as a whole to further reduce the cross-sectional dimensions of the filaments 200E. Alternatively, a plurality of structures (250B) shown in FIG. 2E, i.e., the mechanically reduced matrix embedded with the mechanically reduced filaments 200E, can be inserted to a second matrix (made from a same or different material from that of the first matrix), which can then be further mechanically reduced. It is also contemplated that a plurality of the initial filaments are inserted to a matrix material, and then subject to mechanical reduction and the subsequent procedure depicted in FIG. 2. The procedure (including cutting, inserting, and mechanical reduction) can be repeated for as many times as necessary to obtain the embedded composite filaments with desired dimensions, where at each iteration of the procedure, the number of filaments being simultaneously mechanically reduced can be increased by a factor based on the number of pieces produced by the cutting and the number of the structures being inserted in a matrix at such iteration.

As used herein, “filaments” include fine threads or threadlike structures, and can take a variety of cross sectional shapes, including multilateral, circular, elliptical, or other regular or more complicated shapes. The phrases “mechanically reduce/reducing” and “mechanical reduction” generally refer to a process of reducing the cross-dimensional scale of an object without changing the volume of the object, and includes swaging, drawing, extrusion, rolling and the like.

The initial filament can be previously processed from a larger starting object, e.g., a rod of the composite material. Also, the initial filament can be obtained by inserting the core into a tube of the cladding. Alternatively, the initial filament can be obtained by coating the core with a layer of the cladding, e.g., by electroplating, physical vapor deposition, and the like.

The first matrix can have a tubular structure. The two or more shorter filaments 200C can be inserted as a bundle (not shown) into one cylindrical hole of the first matrix. Alternatively, the first matrix can include a plurality of cylindrical holes, and the two or more shorter filaments 200C can each be inserted into the plurality of cylindrical holes of the first matrix (as illustrated in FIG. 2). In the latter case, the cylindrical holes can be created by drilling using conventional drill bits and mechanical reamers. Inserting the filaments into the matrix holes before further mechanical reduction (as opposed to directly mechanically reducing a bundle of filaments inside a single large hole) can facilitate a uniform reduction and preserves the cross-sectional profile of the filaments and continuity of the cladding layer. Alternatively, if the final material specifications allow for small variations between the filament shape and structure, reducing a bundle of filaments with hexagonal cross section (resulting in a much denser packing fraction, compared to round filaments) can alleviate the above concerns.

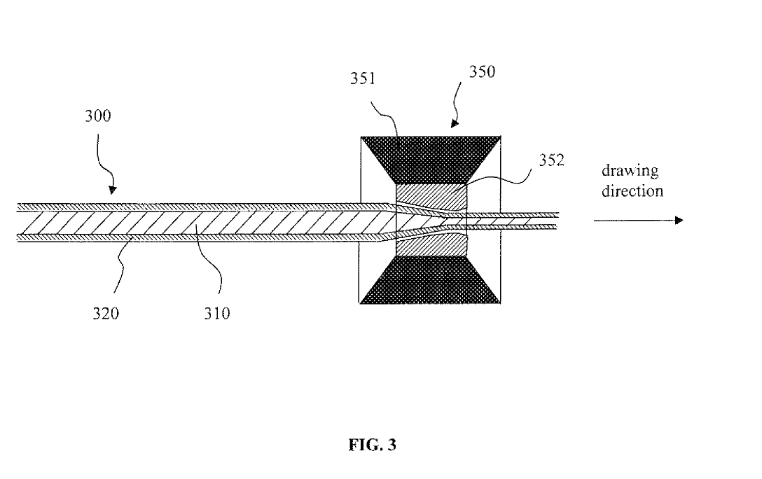

It is understood that initial filaments can be obtained by a similar procedure as outlined herein by starting with objects of much larger size. For example, a starting material to produce the filaments can be a Pt tube of an outer diameter of 25 mm, or larger, with 0.25 mm wall thickness and either an Ag- or Cu- core. For such “macro-filaments” starting material, extrusion can be used to quickly produce the next generation or next few generations of intermediate filaments. Thereafter, the mechanical reduction can include drawing the filaments (with or without the surrounding matrix) using a die. As illustrated in FIG. 3, a die 350 for drawing a filament 300 having a core 310 and a cladding 320 (similar to what is shown in FIG. 2A) can include a casing 351 and a carbide nib 352. When the filament 300 is drawn through the die, its cross sectional dimension is reduced. The die can also be used for drawing a structure including a plurality of filaments and their enclosing matrix (e.g., shown in FIG. 2D).

The cladding can include one or more metals, e.g., Pt-group metals (Pt, Ru, Rh, Pd, Os, Ir), and Au, or alloys thereof. In specific embodiments, the cladding is made from Pt or Pd. The core material can include a metal such as Ag and Cu. Multiphase composites. e.g., multi-filamentary or multilayered composite, such as Ag-Cu, Cu-Nb, Cu-V, Cu-Ta, Cu-Fe, Cu(Ag)-Ni and Cu(Ag)-NiCr can also be used. In general, any pair of ductile metals or alloys that are compatible in terms of their mechanical characteristics can be used as core and cladding, respectively. Likewise, the matrix material can be selected based on its compatibility with the cladding. One consideration for the choice of the core material is the temperature range of the application where the filaments are used. In certain low-temperature applications, the core material can include aluminum or an aluminum-based alloy. At the other end of the temperature extreme and/or for use in highly corrosive atmospheres (e. g. in high-temperature chemical catalysis), the core material itself can be a PGM metal. An example includes a lower cost Pd core with Pt cladding. In specific embodiments, the core is made from Ag and the cladding is made from Pt.

Although the core 210 and cladding 220 are shown in FIG. 2 as directly contacting each other, there can also be a compatibility layer positioned between the core and the cladding. For example, in the case of Pt cladding, the compatibility layer can be Ag to assure the compatibility of the core and cladding metals at the interface, where the core material can be selected based on the overall material characteristics (strength, conductivity, cost, etc). For example, the core material for such case can be Cu.

Before mechanically reducing the initial composite filament, and before performing subsequent mechanical reduction for the shorter filaments of reduced-dimension, annealing can be carried out to relieve stress within the filaments such as that induced by previous treatment. The annealing can also improve the grain structure of the filaments. The annealing (recrystallization) temperature depends on the choice of the cladding and core material and their processing histories. For example, the initial annealing conditions for the starting material can be 1 hour at 500-800° C. for the PGMs, and 1 hour at 300-500° C. for most Ag- or Cu-based cores. Annealing at intermediate stages of the reduction process can also be performed if necessary.

As noted above, the procedure outlined in FIGS. 2A-2F, and variations and/or portions thereof, can be repeated as many times as necessary to produce the final composite filaments with desired dimensions. The cladding thickness of the final filaments can be down to nanometer range, for example, about 10 nm or smaller, or about 5 nm or smaller. In some embodiments, the diameter of the final filaments can be in the order of microns, e.g., 0.1 to 100 microns, such as 5 to 10 microns (e.g., for use in ozone converters), about 1-5 microns (e.g., for use in hydrogen fuel cells or catalytic converters), while the cladding of the final filaments can have a thickness of about 5 microns or smaller, for example, about 1 micron to 5 microns (e.g., for high-temperature chemical catalysis), about 5 nm to 20 nm (e.g., for ozone converter), about 5 nm to 10 nm (e.g., for catalytic converter and hydrogen fuel cells). The size ranges described above are for purpose of illustration only and not for limitation. There is no inherent limit to the length of the final filaments, and the filaments can be made into different lengths for convenience or requirements in different applications. Also, filaments of different sizes and compositions (cladding and core) can be incorporated in a single array at different stages of the reduction process to obtain desired properties of the final material.

When the filaments reach the desired dimensions using the above described procedure, the matrix material is etched away to expose the final filaments. The etching can be carried out by using a chemical that is reactive to the matrix material while unreactive to the cladding material. For example, Ag as a matrix material can be readily etched and removed by using a strong acid such as nitric acid (while the cladding material, such as Pt, Pd, Au, etc., would be inert to the acid).

Once the filaments have been reduced to the final sizes, they can be arranged into an array suitable for a particular application (grid, gauze, fabric, single or multiple layers of parallel filaments, etc). This can be done while the filaments are still embedded in the host matrix (which can contain e.g., 1000 to 1,000,000 filaments). For example, the filaments (e.g., bundles of filaments embedded within the enclosing matrix) can be woven into a fabric. Since the dimensions of the final filaments can be very small, the array of filaments can lack sufficient strength to withstand the handling in weaving. Thus, larger, reinforcing filaments can be added either during the composite reduction process or during the weaving. Depending on the temperature of the application and other external parameters, the reinforcing fibers can be metal fibers or non-metal fibers; the latter can be glass fibers, carbon fibers, nylon or other polymer fibers, etc. Thereafter, the matrix material can be etched away, exposing the array of isolated filaments (the cladding of the filaments is thereby exposed). Such array of the filaments can be used as an electrode material in a battery or a fuel cell. It can also be used as a catalyst in the catalytic converter for reducing pollutants in a flue gas. In the latter case, a suitable cladding material can be Pt, although Pd and Rh can also be used.

A catalytic converter including the final micro-sized composite filaments with thin cladding described above can serve as an auxiliary converter, which can not only reduce the warm-up time for auxiliary close-coupled converters, but bring the warm-up time down significantly, even close-to-zero or zero (“instant light-off”), Moreover, the requirement for the converter to operate at and be resistant to very high temperatures can be reduced, resulting in a greater flexibility for the catalyst choice, a more efficient catalyst performance, and a potential reduction of the total catalyst amount. The auxiliary converter can further replace a close-coupled converter of the automotive catalytic (or be used in conjunction therewith), and is hereinafter referred to as “instant light-off” converter. In one traditional close-coupled converter, the catalyst consists of nanoparticles dispersed inside porous oxide carrier layer and the light-off temperature is reached only when the entire converter is heated sufficiently by the exhaust gases for the catalytic processes to become efficient. By contrast, in the “instant light-off” converter as disclosed herein, the catalytic composite filaments can be heated instantly by resistive heating, thereby eliminating the need for close proximity to the exhaust manifold. For example, the “instant light-off” converter can be placed even downstream from the main three-way converter. This can alleviate material problems due to very high temperatures and provide an additional level of control for both the converter and the engine during idling, in hybrid cars with frequent switching from electric to gas power, and in lean-burn engines.

Similarly, the array of composite filaments obtained from the above procedure can be used as catalytic material for a new generation ozone converter. For example, Pd clad filaments can be heated resistively rather than relying on the preheated air. This also makes it easier and quicker to control the flow of fresh air “on demand” by activating (heating) only a fraction of the converter cells or a fraction of the length of the converter, depending on the occupancy of the aircraft, ozone concentration, and other variables.

The arrays of composite filaments of the disclosed subject matter can be used free of host structures that are commonly used in catalyst loading, such as porous ceramic or other inorganic materials. Therefore, the catalytic surface of the filaments can be more accessible to the reactants.

The structure of the individual filaments (filament diameter, cladding thickness, the choice of the core and cladding material), and of the arrays (filament density, plurality of filaments, arrangement type (grid-like, fabric, gauze, etc)) can be selected depending on the requirements of particular application. For example, operation temperature can vary widely from application to application: from about 80° C. (e.g, hydrogen fuel cells) to intermediate range of 200-300° C. (e.g., ozone converters and automotive catalytic converters), to high temperatures of 800-900° C. used in many chemical catalytic processes. Other requirements that can vary with different applications include filament strength and filament core conductivity (should be low for resistively heated filaments), filament resistance to surrounding (potentially corrosive) gases or liquids and their stability under the influence of electric fields (fuel cells).

In some embodiments, the filament structure can include a PGM cladding layer reduced to an absolute minimum up to and including one monolayer (1 ML) of PGM. In general, the minimum cladding thickness can depend on the choice of the core metal and its chemical resistance to the etchant that is used to remove the matrix metal after the final mechanical reduction. As long as the cladding layer, such as Pt, retains its structural integrity and continuity, the core metal is protected from the etching solution and the mechanical reduction process can continue. At some point, local variations in the thickness of the cladding layer will expose the core metal to the etchant and signal the end of the reduction process. This limit can be extended by interposing a protective, intermediate layer between the core metal and the PGM cladding.

This layer can be mechanically compatible with both core and PGM metal and both chemically and electrochemically inert. One candidate is Au, which can be alloyed to provide a better match to the PGM and core metal work hardening rates. Moreover, the electronic structure of Au can be compatible with Pt catalytic properties even at very small thicknesses, thus providing an additional benefit. An intermediate Au layer can permit an extension of the thickness of the PGM cladding down to the nanometer or even monolayer range. The Au or Au-based layer can be added during the early stage of the process in the form of a thin-walled Au tube, Au foil or can be electrodeposited on the base core metal.

The process discussed above in connection with FIGS. 2A-2F was tested for both Pt and Pd cladding layers. In both cases, the starting materials were 5.0 mm diameter Pd and Pt tubes (0.1 mm wall thickness) with a Ag core. These two assemblies were placed inside a ¼″ O.D. Ag tube (5.0 mm I.D.) that was in turn inserted into a 1″ diameter Cu cylinder with a concentric ¼″ hole. The entire assembly was then extruded from the starting 1″ diameter to the final diameter of ¼″. After drawing this composite to approximately 0.040″, several shorter pieces of both samples were cut off, inserted into pre-drilled holes of a second 1″ Cu cylinder and again mechanically reduced (via extrusion and a series of wire-drawing steps) until the final composite size was 0.5 mm in diameter. Etching the host matrix (Cu and Ag) away revealed an array of uniform filaments, approximately 12.5 micron in diameter with Pt and Pd cladding estimated to be approximately 0.5 micron thick.

In order to fabricate the micron-size filaments with the thickness of the cladding layers in the nanometer range, thin-walled Pt tubes were replaced in the starting assembly with a thin Pt foil (5 to 12.5 micron thick) in combination with a 50-micron Au foil that served as a protective intermediate layer. Following two sets of mechanical reductions (extrusion, wire-drawing and/or rolling), final etching revealed continuous, micron-size filaments and/or ribbons, with an estimated Pt cladding thickness of as little as 10 nm, indicating that further reductions in cladding thickness are possible.

Although Au is an expensive metal, a difference between Au and Pt is its availability. Au is readily available in addition to its significant reserves. Potential applications can include hydrogen fuel cells for automotive and residential applications, hydrogen production, etc. An alternative process can include forming an array of Au-clad filaments and depositing a very thin layer of Pt from a solution in a subsequent process.

The description herein merely illustrates the principles of the disclosed subject matter. Various modifications and alterations to the described embodiments will be apparent to those skilled in the art in view of the teachings herein. Further, it should be noted that the language used herein has been principally selected for readability and instructional purposes, and can not have been selected to delineate or circumscribe the inventive subject matter.

Accordingly, the disclosure herein is intended to be illustrative, but not limiting, of the scope of the disclosed subject matter.

1. A method of fabricating micro-sized composite filaments from an initial composite filament having a first cross sectional dimension, the initial composite filament including a core made from a first material and a cladding made from a second material and enclosing the core, comprising:
(a) mechanically reducing the initial composite filament to produce an intermediate composite filament having a reduced cross sectional dimension;
(b) cutting the intermediate composite filament into two or more shorter filaments;
(c) inserting the two or more shorter composite filaments side by side into a first matrix made from a third material;
(d) mechanically reducing the first matrix with the two or more shorter filaments to further reduce the cross sectional dimensions of the two or more shorter filaments; and
(e) isolating the two or more shorter filaments having further reduced cross sectional dimensions obtained from (d) from the first matrix.

2. The method of claim 1, wherein obtaining the initial composite filament comprises inserting the core into a tube of the cladding.

3. The method of claim 1, wherein obtaining the initial composite filament comprises coating the core with a layer of the cladding.

4. The method of claim 1, wherein the first matrix has a tubular structure, and wherein the inserting comprises inserting the two or more shorter filaments as a bundle into the first matrix.

5. The method of claim 1, wherein the first matrix includes a plurality of cylindrical holes, and wherein the inserting comprises inserting the two or more shorter filaments into the plurality of cylindrical holes of the first matrix.

6. The method of claim 1, wherein the third material is the same as the first material.

7. The method of claim 1, further comprising annealing the initial composite filament before mechanically reducing the initial filament.

8. The method of claim 1, where the isolating comprises chemical etching the first matrix material.

9. The method of claim 1, wherein the initial composite filament further includes a compatibility layer positioned between the core and the cladding.

10. The method of claim 1, wherein the first material comprises a metal selected from the group consisting of Ag and Cu.

11. The method of claim 1, wherein the first material comprises a multiphase composite selected from the group consisting of Ag-Cu, Cu-Nb, Cu-V, Cu-Ta, and Cu-Fe, or a multilayer composite such as Cu(Ag)-Ni or Cu(Ag)-NiCr.

12. The method of claim 1, wherein the first material comprises an aluminum-based alloy.

13. The method of claim 1, wherein the second material comprises Pt.

14. The method of claim 1, wherein the second material comprises a metal selected from the group consisting of Ru, Rh, Pd, Os, Ir, and Au.

15. The method of claim 1, wherein the cladding of the two or more shorter filaments having further reduced cross sectional dimension obtained in (d) has a thickness of about or smaller than 10 nm.

16. The method of claim 1, wherein the cross sectional dimension of the two or more shorter filaments having further reduced cross sectional dimension obtained in (d) is about or smaller than 2 micron.

17. The method of claim 1, further comprising, before (e):
cutting the mechanically reduced first matrix with two or more shorter filaments embedded within the first matrix obtained in (d) into a plurality of composite structures;
inserting the plurality of composite structures into a second matrix made from a fourth material; and
mechanically reducing the second matrix with the plurality of composite structures inserted therein.

18. The method of claim 1, further comprising:
forming an array of filamentary structures from the mechanically reduced matrix with the two or more shorter filaments as obtained from (d).

19. The method of claim 18, wherein the forming comprises weaving.

20. The method of claim 18, wherein the forming comprises adding reinforcing fibers.

21. A method of fabricating micro-sized filaments, comprising:
(a) obtaining at least one initial composite filament having a first cross sectional dimension, the initial composite filament including a core made from a first material and a cladding made from a second material and enclosing the core;
(b) inserting the at least one initial composite filament into a first matrix made from a third material;
(c) mechanically reducing the first matrix of the third material with the at least one initial composite filament to reduce the cross sectional dimension of the at least one initial composite filament, thereby obtaining at least one filament having a reduced cross sectional dimension; and
(d) isolating from the first matrix the at least one filament having the reduced cross sectional dimension obtained in (c).

22. The method of claim 21, wherein the at least one initial composite filament includes a plurality of initial filaments, and wherein the inserting comprises inserting the plurality of initial filaments into the first matrix.

23. The method of claim 22, wherein the plurality of initial filaments include filaments having different compositions or sizes.

24. The method of claim 21, wherein the at least one initial composite filament further includes an outer layer made from a fourth material in contact with the cladding.

25. The method of claim 24, wherein the fourth material is a same material as the third material.

26. A composite filament comprising:
a core made from a first material, the first material including a metal selected from the group consisting of Ag and Cu,
a cladding made from a second material and enclosing the core, the second material including a metal selected from the group consisting of Pt, Ru, Rh, Pd, Os, Ir, and Au; and
wherein the cladding has a thickness of about or smaller than 50 nm.

27. The composite filament of claim 26, wherein the cladding has a thickness of about or smaller than 10 nm.

28. The composite filament of claim 26, wherein the first material includes Ag, and the second material includes Pt.

29. The composite filament of claim 26 fabricated according to the method of claim 1.

30. An array of composite filaments including a plurality of the composite filament of claim 24.

31. The array of composite filaments of claim 30, wherein the plurality of composite filaments include filaments having different compositions or sizes.

32. The array of composite filaments of claim 30, wherein the array is in the form of a woven fabric.

33. The array of composite filaments of claim 32, further comprising reinforcing fibers.

34. An electrode for an electrochemical cell comprising the array of composite filaments of claim 30.

35. A hydrogen fuel cell including the electrode of claim 34.

36. A catalytic converter for reducing pollutants in a flue gas, comprising the array of composite filaments of claim 30.

37. The catalytic converter of claim 36, wherein the second material comprises Pt.

38. An ozone converter comprising the array of composite filaments of claim 30.

39. The ozone converter of claim 38, wherein the cladding material is Pd.
